(19) United States
(12) Patent Application Publication
(10) Pub. No.: US 2025/0364944 A1
(43) Pub. Date: Nov. 27, 2025

(54) T-Bar Support System and Method for Solar Modules

(71) Applicant: JA Solar USA Inc., San Jose, CA (US)

(72) Inventor: Teodor GALITEV, Fountain Valley, CA (US)

(73) Assignee: JA Solar USA Inc., San Jose, CA (US)

(21) Appl. No.: 19/216,654

(22) Filed: May 22, 2025

Related U.S. Application Data
(60) Provisional application No. 63/651,375, filed on May 23, 2024.

(51) Int. Cl. H02S 20/32

(52) U.S. Cl. CPC H02S 20/32

(57) ABSTRACT

Embodiments of the present disclosure are directed to an apparatus (also referred to as a T-bar, or torque-bar support) having an elongated, anodized tubular member (12) that attaches to a solar module frame (30). The tubular member (12) has one or more holes that align with holes (22) on the solar module frame (30). The T-bar apparatus (10) also includes a silicone gasket (14) to protect the glass (26) from damage and strengthen the amount of loading of the solar module (20). On the side of the tubular member (12), a preinstalled grounding washer (16) ensures that when installed the torque-bar support (10) is electrically grounded. A typical solar module (20) includes two or more T-bar supports (10) that are spaced apart and symmetrical to a center location of the solar module (20).

### CROSS REFERENCE TO RELATED PATENT APPLICATION

This application claims priority to U.S. Provisional Application Ser. No. 63/651,375 entitled “T-Bar Support System and Method for Solar Modules,” filed on 23 May 2024, the disclosure of which is incorporated herein by reference in its entirety.

### TECHNICAL FIELD

The present invention relates generally to solar technologies and, more particularly, to solar modules that handles load bearing.

### BACKGROUND OF INFORMATION

The solar power industry has grown rapidly over the past decade, as more environmentally-conscious countries are advancing renewal energy and conserving earthly resources to combat against global warming and climate change. The urgency to scale back on carbon emissions cannot be overstated, as global leaders gather at annual United Nations Climate Change Conference, known as Conference of Parties. The increased use of solar energy is a centerpiece strategy to reduce the reliance on petroleum, along with other several solar initiatives that have been launched.

Constructions of solar farms and solar projects, plus installations of solar panels at offices and residential homes, provide an energy efficient mechanism to absorb the sun's rays as a source of energy for generating electricity or heating. A solar module or a photovoltaic (PV) module is a packaged and connected assembly with a matrix of solar cells. Each solar module is rated by its direct current (DC) output power under a set of test conditions. One industrial leading company designing and manufacturing solar cells and solar modules is JA Solar Holdings Co., Ltd., www.jasolar.com.

As the solar industry continues to advance, the market is seeking a greater demand for lower cost products while focusing increased demand for high quality, superior electrical and mechanical performance. Some of the challenges can be attributed to climate changes that cause strong winds or excessive coldness. Solar modules that are not able to handle the added mechanical loading may break. Solar installation companies may encounter a wide range of module installation sites that have vastly different mechanical load requirements and expectations. The installation sites are becoming more and more demanding of higher loads and impact resistance.

Some solar companies may be at a dilemma to address higher load and resistance, because it can be difficult to justify a stronger mass-produced module for significantly increased load. Such modules could result in higher, uncompetitive pricing in geographical regions that do not necessarily require the increased loads. In addition, many actual situations may need just a small percentage, such as 5% to 15%, of the modules to carry increased loading. It can be burdensome for solar companies to provide custom modules across various load requirements.

Potential liability is another issue, which currently is typically solved by racking companies that offer larger clamps or supports that a company needs to test and approve, as well as carrying liability. While the racking company may receive a payment for that hardware, in many cases that can be just a few cents, e.g. 3-5 cents a watt. If a solar modules breaks, it is likely that a solar module supplier would have to provide product warranty and replacement, where the solar module supplier may have to absorb the costs without an effective way to get compensated or reimbursed for the potential liability.

In one example, a solar module supplier typically provides residential systems that have a hurricane level strength where the residential system may be installed on three or four mounting rails. This likely significantly increases the solar project cost without being able to increase the solar module price while a solar company is subject to potential liabilities if a solar module breaks. Similar examples exist and are applicable for utility systems.

Increasingly, solar modules are installed in the field that are becoming bigger, which can make the solar modules vulnerable to breakage on different installation techniques. One reason for the breakage derives from the fact that the solar modules may not be designed to carry and withstand a requisite mechanical load on a particular site, or the mechanical load of the solar modules is near or at the limit of the loading requirements. Replacing existing solar modules with larger solar modules, or installing larger solar modules, to meet a mechanical loading requirement may incur higher costs that may price out certain segments of buyers.

Accordingly, it is desirable to design an apparatus that provides additional mechanical load to strengthen a solar module to withstand environmental impacts.

### SUMMARY OF THE DISCLOSURE

Embodiments of the present disclosure are directed to an apparatus (also referred to as a T-bar, or a torque-bar support) with an anodized aluminum support that fits inside a solar module frame, which has one or more holes that match holes on the solar module frame. The T-bar apparatus also includes a silicone gasket to protect the module back glass from contact damage. On one side, a preinstalled grounding washer ensures that when installed the torque-bar support is grounded. A typical solar module includes two or more T-bar supports, as an example, resulting in the module load capacity exceeding 5400 Pa up and down. The load can be for a ground mount or a tracker system.

In one embodiment, a solar manufacture manufactures a standard solar module product, with the standard load bearing specifications and standard frame. In this embodiment, the T-bar support is a separate piece that can be mounted in the solar module to improve the mechanical loading threshold. All solar modules remain the same. If a customer requires a higher load capable module, it can be added as a line item on an invoice with the specific amount of support. The installation of torque-bar supports is done by an installer while installing a solar module. Installation can be implemented with one or more (or a plurality of) screws, or with the original bolts or rivets used to attach the solar module. The T-bar supports by themselves, or in combination with one or more rail attachments, can be installed to any matching holes to a frame.

In one embodiment, while the pricing of a solar module remains unchanged, the T-bar support system becomes a line item in an invoice. Installation may be done in the field by a customer. Load bearing can be up to +/−5400 pascals (Pa) with an increased hail impact stability. In one example, the expected volumes for such a product are in the range of 250,000 sets per Gigawatt (GW).

In one embodiment, the torque-bar support is added in the field of existing solar modules and by a customer. It does not have to done at a factory. The torque-bar support is a (separate or independent) piece of apparatus which can be added to a solar module to improve the mechanical characteristics of the solar modules in the field. The torque-bar support improves the mechanical characteristics of each solar module. For example, the torque-bar support can improve low bearing mechanical characteristics of a solar module, e.g., with over 30% load bearing improvements.

Broadly stated, a solar module (20), comprises a solar module frame (30) surrounding a sheet of glass (26) overlaying a plurality of solar cells, the solar module frame (30) having a first column of holes (or a first row of holes (22a) and a second column of holes (or a second row of holes) (22b), the solar module frame (30) having a set of mechanical loading characteristics with a predetermined loading threshold to withstand a meteorological impact from breaking the glass (26); a first torque-bar apparatus (10) attached over the glass and positioned on a first side of the solar module frame (30) to provide an enhanced set of mechanical loading characteristics with an increased predetermined loading threshold to withstand the meteorological impact from breaking the glass (26), the first torque-bar apparatus (10) including a first body metal tubular member (12a), a first gasket (14), and a first grounding washer (16), the first torque-bar apparatus (10) including a first plurality of holes positioned to match respective positions of the first column of holes (22a) in the solar module frame (30), the first gasket (14) being disposed between the glass (26) and the first body metal tubular member (12a) to provide a physical separation between the glass (26) and the first body metal tubular member (12a), thereby protecting the glass (26) from damage, the first grounding washer (16) being attached to the first body metal tubular member 12a for providing electrical grounding between the first body metal tubular member (12) and the solar module frame (30); and a second torque-bar apparatus (10) attached over the glass (26) and positioned on a second side of the solar module frame (30) to provide the enhanced set of mechanical loading characteristics with an increased predetermined loading threshold to withstand the meteorological impact from breaking the glass (26), the second torque-bar apparatus (10) including a second body metal tubular member (12b), a second gasket (14), and a second grounding washer (16), the second torque-bar apparatus (10) including a second plurality of holes positioned to respective positions of the second column of holes (22b) in the solar module frame (30), the second gasket (14) being disposed between the glass (26) and the second body metal tubular member (12b) to provide a physical separation between the glass (26) and the body metal tubular member (12b), thereby protecting the glass (26) from damage, the second grounding washer (16) being attached to the second body metal tubular member (12b) for providing electrical grounding between the second body metal tubular member (12) and the solar module frame (30).

The first body metal tubular member (12a) in the first torque-bar apparatus (10) is spaced apart from the second body metal tubular member (12b) by a distance as determined by the amount of the enhanced set of mechanical loading characteristics with the increased predetermined loading threshold to withstand the meteorological impact from breaking the glass (26).

The enhanced set of mechanical loading characteristics strengthens the set of mechanical loading characteristics by at least 30% maximum loading capacity.

The first torque-bar apparatus comprises an anodized aluminum material or a steel material. The second torque-bar apparatus comprises an anodized aluminum material or a steel material.

The first torque-bar apparatus is bolted onto the solar module frame (30) with a first set of one or more screws, and wherein the second torque-bar apparatus is bolted onto the solar module frame (30) with a second set of one or more screws.

The first torque-bar apparatus (10) is attached to the solar module frame (30) with a first set of rivets; and the second torque-bar apparatus (10) is attached to the solar module frame (30) a second set of rivets.

The grounding washer (16) comprises a geometric shape, including circular, square, or rectangular.

In one embodiment, each gasket (14) comprises a silicone gasket, a rubber gasket, or a non-rubber material.

In one embodiment, each gasket (14) comprises a spongy material or a spongy silicone.

In one embodiment, each gasket (14) is sufficiently thick to touch the glass when the corresponding body metal tubular member is mounted to the solar module frame (30).

In one embodiment, each gasket (14) has a thickness dependent on an original size of the solar module frame (30).

In one embodiment, each grounding washer (16) comprise stainless steel.

In one embodiment, the first body metal tubular member (12a) and the second body metal tubular member (12b) are spaced apart by approximately 400 millimeter.

In one embodiment, the first body metal tubular member (12a) and the second body metal tubular member (12b) are spaced apart by approximately 1,200 millimeter.

In one embodiment, the first body metal tubular member (12a) and the second body metal tubular member (12b) are paced apart by approximately 1,400 millimeter.

Advantageously, the T-bar support system provides an effective and economical solution to bolster the load requirements of solar modules at geographical locations that may be subject to dramatic environmental forces, such as hurricanes or heavy snowfall that put undue amount of loading onto and potentially break the glass on the solar modules.

The structure and methods of the present invention are disclosed in the detailed description below. This summary does not purport to define the invention. The present invention contains different embodiments, which may be applied to various different environments. Variations upon and modifications to these embodiments are provided for by the present invention, which is limited only by the claims. These and other embodiments, features, aspects, and advantages of the invention are better understood with regard to the following description, appended claims, and accompanying drawings.

### BRIEF DESCRIPTION OF THE DRAWINGS

The disclosure is described with respect to specific embodiments thereof, and reference will be made to the drawings, in which:

FIG. 1 is a structural diagram illustrating one embodiment of a T-bar support 10 with a body metal tube (or a body metal tubular member) 12, a silicone gasket 14 and a washer 16 in accordance with the present invention.

FIG. 2 is a structural diagram illustrating an assembled T-bar support 10 with the body metal tubular member 12, the silicone gasket 14 and the washer 16 in accordance with the present invention.

FIG. 3 is a structural diagram illustrating one embodiment of the body metal tubular member 12, the rubber gasket 14 and the grounding washer 16 in accordance with the present invention.

FIG. 4 is a structural diagram illustrating a side view of FIG. 3 with the body metal tubular member 12 (e.g., an aluminum tubular member) with the silicone gasket 14 in accordance with the present invention.

FIG. 5 is a structural diagram illustrating a first embodiment of a solar module 20 with the addition of a plurality of the T-bar supports 10, mounted to a set of holes that are 400 millimeter (mm) apart in accordance with the present invention.

FIG. 6 is a structural diagram illustrating one embodiment of the solar module with the plurality of body metal tubular members (T-bars) 12 mounted to a set of holes that is 400 millimeters apart with respect to FIG. 5 in accordance with the present invention.

FIG. 7 is a structural diagram illustrating a close-up (or zoomed-in) view of the first embodiment of the body metal tubular members 12a, 12b mounted to a set of holes that is 400 millimeters apart in accordance with the present invention.

FIG. 8 is a structural diagram illustrating a second embodiment of the body metal tubular members 12a, 12b mounted to a set of holes that is 1,200 millimeters apart in accordance with the present invention.

### DETAILED DESCRIPTION

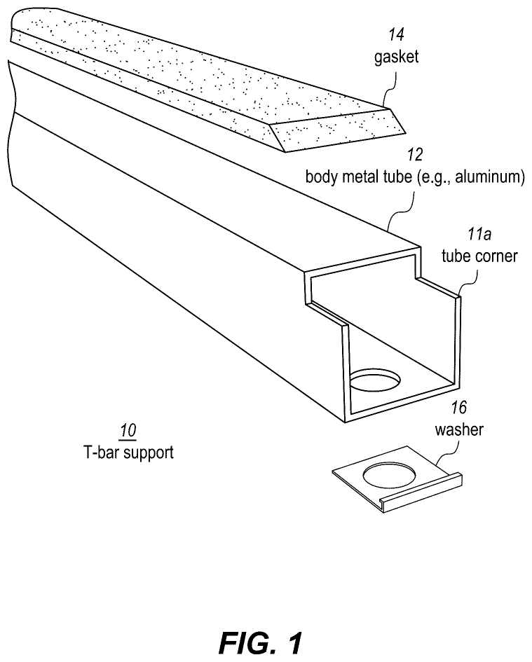

A description of structural embodiments and methods of the present invention is provided with reference to FIGS. 1-8. It is to be understood that there is no intention to limit the invention to the specifically disclosed embodiments but that the invention may be practiced using other features, elements, methods, and embodiments. Like elements in various embodiments are commonly referred to with like reference numerals. In the following description, for purposes of explanation, numerous specific details are set forth in order to provide an understanding of various embodiments of the inventive subject matter. It will be evident to those skilled in the art, however, that embodiments of the inventive subject matter may be practiced without these specific details. In general, well-known instruction instances, protocols, structures, and techniques have not been shown in detail.

The following definitions apply to the elements and steps described herein. These terms may likewise be expanded upon.

### Metal Tube (or Metal Tubular Member) (16)

FIG. 1 is a structural diagram illustrating one embodiment of a T-bar support (also referred to as “a T-bar apparatus”, “a T-bar element”, “a torque-bar apparatus”, or “torque-bar element”) 10 with a body metal tube 12, a silicone gasket 14 and a washer 16. The body metal tube 12 of the T-bar support 10 has mechanical properties sufficiently strong to support a solar module 20. The thickness of the body metal tube 12 can vary depending on the material selected to make the body metal tube 12 sufficiently strong to support the solar module 20. The body metal tube 12 can be made out of aluminum or steel. In this embodiment, the body metal tube 12 has a square cross-section. The cross-section of the body metal tube 12 can be implemented in another geometric shape, such as square, cylindrical (round), rectangular, oval, triangular, hexagonal or another shape. Both sides of the body metal tube 12 are symmetrical in this embodiment. In one example, the body metal tube 12 is an aluminum tube, with dimensions of about 20″×20″×1.5″, with a hole size that matches the holes in a solar module frame 30 in the solar module 20. The body metal tube 12 can also be implemented with steel. The actual material of the body metal tube 12 depends on the desirable wall thickness.

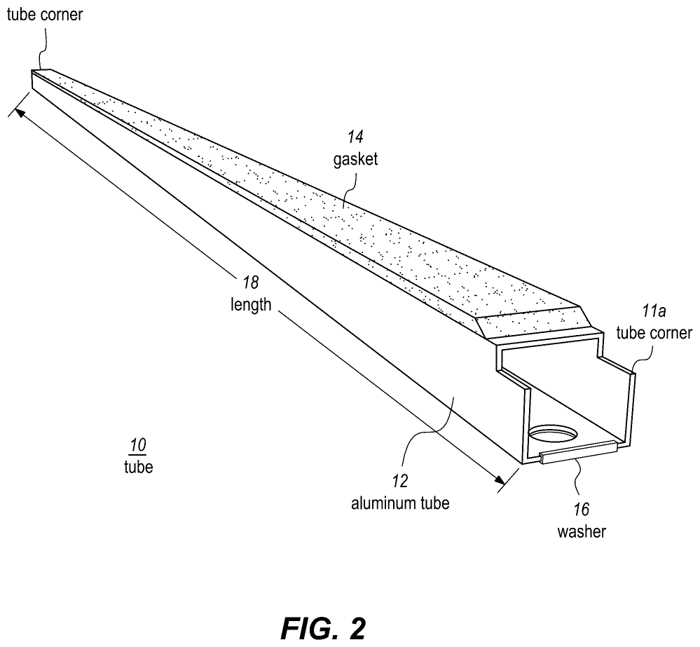

The body metal tube 12 has a length 18 and two corners 12a, 12b (also referred to as “tube corners”), as shown in FIG. 2. The body metal tube 12 has the first tube corner 11a on a first side and the second tube corner 11b on a second side facing the first side. In one embodiment, the first tube corner 11a and the second tube corner 11b are identical. In another embodiment, the first tube corner 11a is designed differently than the second tube corner 11b.

### Gasket (14)

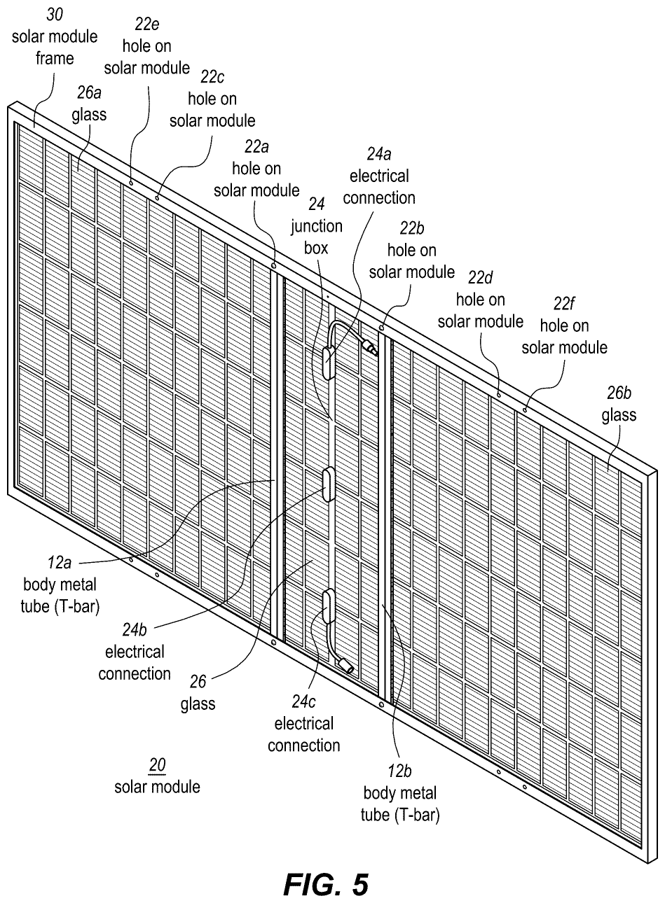

The gasket 14 can be made of silicone, rubber, or non-rubber material (e.g., a silicone gasket or a rubber gasket). The rubber gasket 14 is selected with a cushion material for contact with the solar module 20 (as shown in FIG. 5). The rubber gasket 14 is in physical contact with the solar module 20. The rubber gasket 14 is placed (or disposed) between a back glass and a metal to provide a physical separation between the back glass 26 (as shown in FIG. 5) with the solar module 20 and the metal; to phrase it another way, there is no contact between the glass 26 and the metal, as the rubber gasket 14 serves as a physical separation. The rubber gasket 14 protects the glass from the metal tube 12 so the glass does not shatter. The thickness of the silicone gasket 14 may be made to depend on the original frame size. The silicone gasket 14 remains flexible and compressible, for example having up to 25% compressibility.

In one embodiment, the silicone gasket 14 is sufficiently thick to touch the glass 26. The silicone gasket 14 is positioned in a physical location between the metal and the glass 26. In one example, the silicone gasket 14 comprises spongy material, such as spongy silicone. When the T-bar support 10 is placed on the glass 26, the T-bar support 10 can press a bit due the spongy material of the silicone gasket 14. A solar module can vary in many different sizes so the gasket thickness (or the thickness of the gasket 14) can vary depending on a module size.

### Grounding Washer (16)

The washer 16 can be manufactured in stainless steel, which provides electrical continuity (or electrical connection) between the metal tube and the metal frame of the solar module 20, grounding to the solar module frame 30 of the solar module 20. In one embodiment, a profile of the washer 16 has a hole through which an installer can insert his or her finger for aligning the hole in the washer 16 with a hole on the body metal tube 12. However, if the installer is using rivets in the bottom, there may not be a need to access the hole in the washer 16. In the illustrated example, the shape of the grounding washer 16 is circular. The grounding washer 16 can be implemented in any geometric shape, including circular, rectangular, square, or another shape. The placement of a matching hole (or one or more holes) on the body metal tube 12 can be at any location(s) on the body metal tube 12, depending on the desired mechanical characteristics.

FIG. 2 is a structural diagram illustrating the T-bar support 10 with the body metal tube 12, the silicone gasket 14 attached to the body metal tube 12 and the washer 16. The silicone gasket 14 is disposed above a surface of the body metal tube 12. In one embodiment, the silicone gasket 14 is glued to a surface of the body metal tube 12. In this embodiment, the body metal tube 12 has an anodized or galvanized coating, to prevent corrosion. The washer 16 is inserted into a part of the body metal tube 12. A suitable supplier of the T-bar support 10 is JA Solar USA Inc., located in San Jose, California, for use with JA Solar or other solar manufacturers' solar modules. The solar modules may require load bearing while complying with all installation regulations, such as but not limited to, grounding, salt mist, fire rating, etc. In one example, the T-bar support 10 can also be installed retro-actively, where a solar module supplier may be willing to confidently assume the liability for such solar modules.

The T-bar support 10 provides attractive commercial value: (1) increased hail impact and load bearing capability, (2) liability may be covered by a company, (3) project insurance cost may be significantly reduced, (4) may significantly reduce the cost for racking hardware and (5) easy installation. The total cost of two T-bar supports (considered to be one set) may be manufactured with relative low pricing.

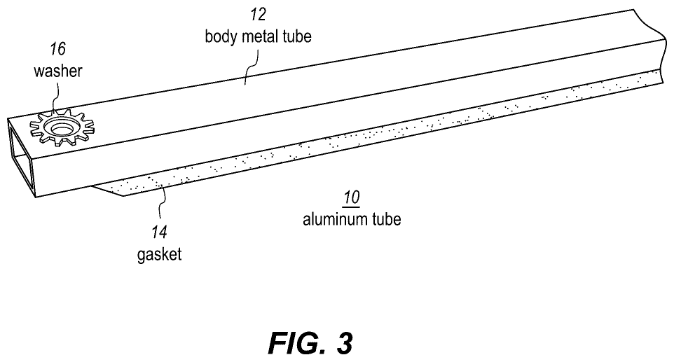

FIG. 3 is a structural diagram illustrating one embodiment of the body metal tube 12, the rubber gasket 14 and the grounding washer 16. In this particular diagram, the rubber gasket 14 is in physical contact and glued to a first surface (bottom) of the body metal tube 12. The grounding washer 16 is inserted into a hole on a second surface (top) of the body metal tube 12. The purpose of the grounding washer is to provide electrical grounding between the body metal tube 12 and the solar module frame 30. The shape of the grounding washer 16 in this embodiment is circular with a plurality of star edges. The grounding washer 16 can also be implemented in any geometric shape, including circular, rectangular, square, oval and other shapes. The length of the rubber gasket 14 can vary, i.e., longer or shorter, dependent on design choice for a particular solar module 20. In one embodiment, the length of the rubber gasket 14 should be sufficiently long to prevent damage to the solar module 20 which the body metal tube 12 is mounted.

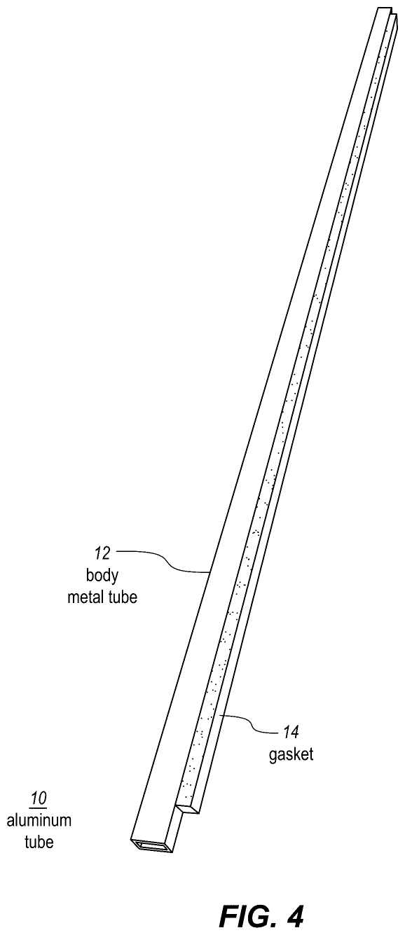

FIG. 4 is a structural diagram illustrating one embodiment of the body metal tube 12 (e.g., an aluminum tube) with the silicone gasket 14 adhered to the body metal tube 12 as FIG. 3. In this example, the cross-section of the body metal tube 12 is about 0.75 inch (or 0.75″) square and the silicone gasket 14 is relatively thick as for a 35 mm frame profile. For a 30 mm frame, the silicone gasket 14 can be thinner.

FIG. 5 is a structural diagram illustrating a first embodiment of the solar module 20 with the addition of a plurality of the body metal tubes (or T-bar tubes) 12a, 12b, mounted to a 400 millimeter holes. In this embodiment, initially, the solar module 20 may be installed in a field without the two T-bar support 10 comprising the body metal tubes, 12a, 12b. To strengthen the solar module 20, the plurality of body metal tubes 12a, 12b are added or mounted to the solar module 20. In this example, there is the first body metal tube 12a (in a first T-bar support 10) mounted to the left side of the solar module 20 with a first bolt (or a first screw) through a hole 22a, and the second body metal tube 12b (in a second T-bar support 10) mounted to the right side of the solar module 20 with a second bolt (or a second screw) through a hole 22b. The mounting or placement of the body metal tubes 12a, 12b can be selected depending where suitable holes 22a, 22b, 22c, 22d, 22e, 22f are available on the solar module for mounting the body metal tubes 12a, 12b. The addition of the two the body metal tubes 12a, 12b in T-bar supports 10 can improve the mechanical loading characteristics of the solar module 20 by over 30 percent.

In this example, the body metal tubes 12a, 12b in the T-bar supports 10 are mounted respectively to the first hole 22a and the second hole 22b. The distance between the two symmetric holes 22a, 22b, which are normally evenly spaced with respect to a junction box 24 which is placed in the middle (or center) of the solar module 20, is about 400 mm. In another example, the first T-bar support 12a is mounted to a third hole 22c, while the second body metal tube 12b in the T-bar support 10 is mounted to a forth hole 22d. The distance between the two symmetric holes 22a, 22b, which are normally evenly spaced with respect to a the junction box 24 that is placed in the middle (or center) of the solar module 20, is about 1200 mm. In a further example, the first T-bar support 12a is mounted to a fifth hole 22e, while the second body metal tube 12b in the second T-bar support 10 is mounted to a sixth hole 22f. The distance between the two symmetric holes 22e, 22f, which are normally evenly spaced with respect to the junction box 24 that is placed in the middle (or center) of the solar module 20, is about 1400 mm. The junction box 24 typically includes a first electrical connection 24a, a second electrical connection 24b, and a third electrical connection 24c.

As an example, the solar module frame 30 shown in FIG. 5 is placed just outside the glass 26, glass areas 26a, 26b of glass 26 may not have the T-bar support 10. When a load is applied on top of the solar module 20, the glass portions 26a, 26b in the glass 26 deflect. If the load is increased to a certain level (or predetermined level, or a threshold level), the glass portions 26a, 26b in the glass 26 may bend down potentially breaking the glass. To phrase it another way, as an example, when excess load is applied from the top of the solar module frame 30, the glass portions 26a, 26b in the glass 26 may warp with the T-bar support 10. Excess (or too much) loading to the solar modules 20 is characteristic scenarios that can come from, for example, meteorological impact, such as hurricanes, strong winds, or heavy snowfall that significantly cause an increase in the loading to the glass on the solar module frame 30 of the solar module 20 that can exceed a predetermined loading threshold. Heavy snow can push down loading pressure toward the center of the solar module 20. Without the T-bar support 10, the glass portion 26a (and/or 26b) may bend as the glass portion 26a (or 26b) is not able to support weight of the excess loading. Sometimes, the glass 26a, 26b, may bend slightly but remain still intact and functional. However, if the glass 26a, 26b, bends excessively (or too much), the glass 26a, 26b may break.

The solar module 20 is typically protected by a layer of low-iron, tempered glass 26 with an anti-reflective coating, providing high light transmittance, mechanical durability, and resistance to environmental factors such as hail, snow, wind and oxidation. In one embodiment, a single sheet of glass 26 covers all the photovoltaic (PV) cells within the solar module 20, protecting the cells environmental factors while allowing sunlight to reach the cells (Tosho, please check). The solar cells are laminated between a front glass and a back sheet (for example, a back sheet is typically back glass).

The placement of body metal tube 12a, 12b in the T-bar supports 10 in specific locations on the solar module 20 increases (or strengthens) the loading threshold level, which may prevent the glass 26a (or 26b) from bending or breaking, provided the excess loading does not exceed a loading level beyond the normal loading level plus the additional loading from the body metal tube 12a (and/or 12b) in the T-bar support(s) 10. In the event that excess loading is extreme exceeding even the heightened loading provided by the body metal tubes 12a, 12b in the T-bar supports 10, the glass 26a (and/or 26b) may still break. In one example, the body metal tube 12a, 12b in the T-bar supports 10 provide at least 30% (or more) additional loading threshold (for example, can bear 30% more weight) compared to a normal predetermined threshold level without the body metal tube 12a, 12b in the T-bar support(s) 10. In one example, the glass 26 in the solar module 20 may be able to withstand up to two thousand, four hundred (2,400) pascals without the T-bar support 10. With the T-bar support(s) 10, the glass 26, in the solar module 20 can strengthen the loading to 3,200 pascals, sometime even up to 3,600 pascals or more.

One or more T-bar supports 10 can be placed at one or more holes, 22a, 22b, 22c, 22d, 22e and/or 22f. As a first example with respect to FIG. 5, with a first set of mechanical characteristics, the first body metal tube 12a in the T-bar support 10 is placed at the hole 22a while the second T-bar support 12b is placed at the hole 22b, which creates a distance of approximately 400 millimeters for the enhanced loading support provided between the first body metal tube 12a/first T-bar support 10 and the second body metal tube 12b/second T-bar support 10. As a second example with respect to FIG. 5, with a second set of mechanical characteristics, the first body metal tube 12a in the T-bar support 10 is placed at the hole 22c while the second the second body metal tube 12b in the T-bar support 10 is placed at the hole 22d, which then creates a distance of approximately 1,200 millimeters for the enhanced loading support provided between the first body metal tube 12a in the first T-bar support 10 and the second body metal tube 12b in the second T-bar support 12b. As a third example, with respect to FIG. 5 with a third set of mechanical characteristics, the first body metal tube 12a in the T-bar support 10 is placed at the hole 22e while the second body metal tube 12b in the second T-bar support 10 is placed at the hole 22f, which creates a distance of approximately 1,400 millimeters for the enhanced loading support provided between the first body metal tube 12a in the first T-bar support 10 and the second body metal tube 12a in the second T-bar support 10. Depending on the placement of one or more metal body tubes 12a, 12b in the T-bar support(s) 10 on the solar module 20, the effect of the loading may be different such that the first set of mechanical characteristics is different from the second set of mechanical characteristics and the first and second sets of mechanical characteristics may be different from the third set of mechanical characteristics.

As an example, for hurricane-pronged areas include coastal regions in Florida, the building requirements can be very strict for hurricane winds, such as Wind Zone 4 for winds up to 170 miles per hour (mph), or high-velocity hurricane zones (HVHZ) that require solar modules 20 wo withstand winds of 170 mph, 175 mph, 180 mph, or even 185 mph. Solar modules that are installed in a conventional way would likely break and not be able to withstand the loading of a 170 mph wind. Practically, customers in the coastal regions of Florida would request that a solar company provide a warranty that solar modules installed will be able to withstand 170 mph wind. The use of a plurality of T-bar supports 10 by themselves, or in combination with rails, on each solar module 20 may provide the additional loading required to withstand 170 mph winds.

Although one solar module 20 is illustrated in FIG. 5, the present invention can be applied to multiple solar modules (or a plurality of solar modules) that are connected together to form a solar array for commercial, utility, or residential installations. For large-scale installations, solar modules can form an electric grid to build a solar farm.

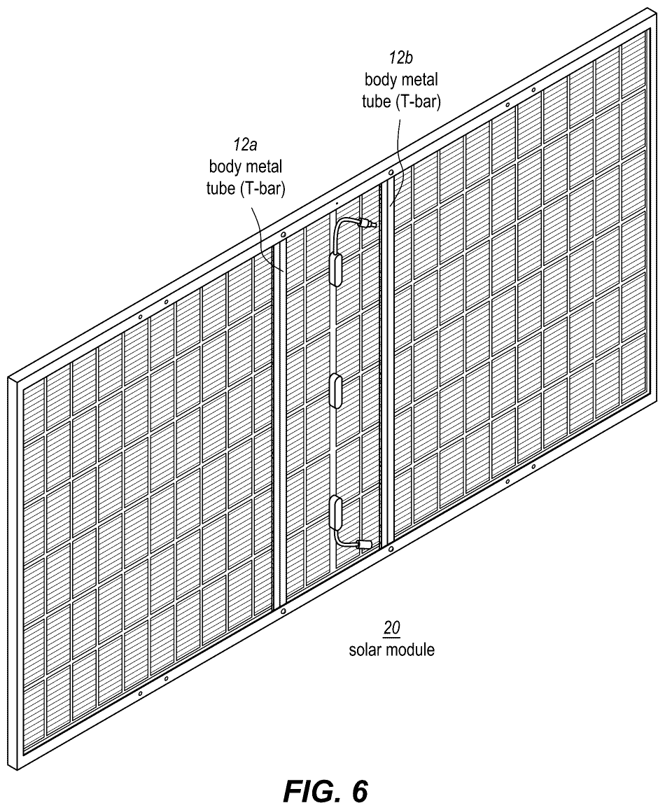

FIG. 6 is a structural diagram illustrating one embodiment of the solar module 20 having the plurality of body metal tubes 12a, 12b in T-bar supports 10 mounted to a set of symmetrical holes that is 400 millimeter apart as in FIG. 5.

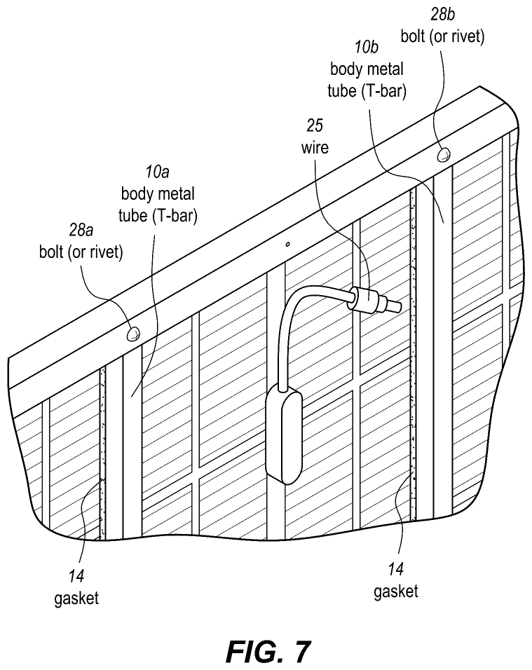

FIG. 7 is a structural diagram illustrating a close-up (zoomed-in) view of a first embodiment of a pair of body metal tubes 12a, 12b mounted to a corresponding pair of holes via the bolts 28a, 28 that is 400 millimeter apart. Each bolt 28a, 28b is inserted through a respective washer 16 and the frame of the solar module 20. The bolts 28a, 28b can be implemented with a conventional bolt or with a rivet. The respective washer 16 provides a means for electrically grounding the solar module 20.

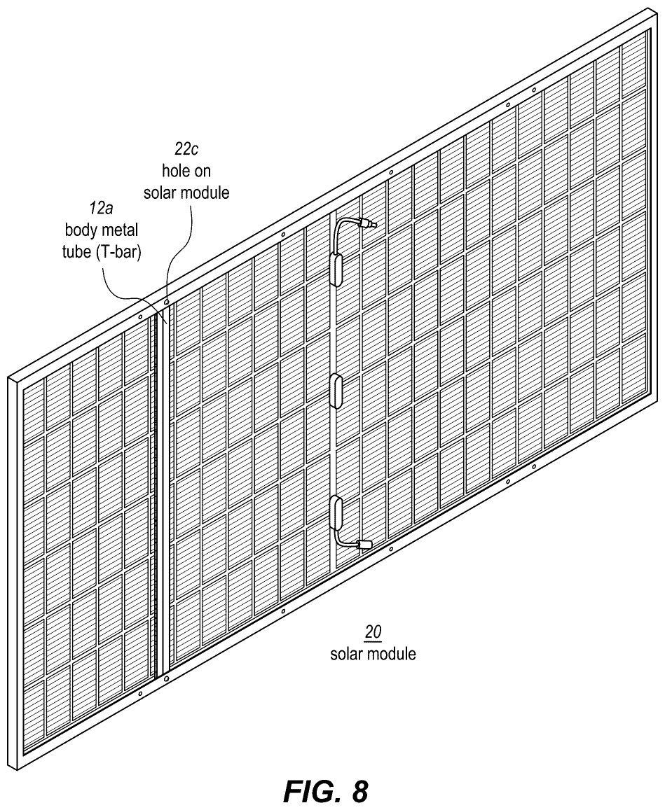

FIG. 8 is a structural diagram illustrating a second example of a pair of body metal tubes 12a, 12b (the body metal 12b shown in FIG. 5) bolted to a corresponding pair of holes 22c, 22d (hole 22d shown in FIG. 5) that is approximately 1,200 millimeter apart. The first body metal tube 12a can be mounted a first (or left) side of the solar module 20 (as shown in FIG. 5) and can. Be positioned about 1,200 millimeter away from the second body metal tube 12b that can be mounted on a second (or right) side of the solar module 20. A typical distance gap between the mounting of the first body metal tube 12a and second body metal tube 12b is approximately 1200 mm.

A solar modules system comprises a plurality of solar modules (20), each solar module (20) including a solar module frame (30) surrounding a sheet of glass (26) overlaying a plurality of solar cells, the solar module frame (30) having a first column of holes (or a first row of holes) (22a) and a second column of holes (or a second row of holes) (22b), the solar module frame (30) having a set of mechanical loading characteristics with a predetermined loading threshold to withstand a meteorological impact from breaking the glass (26); and a plurality of torque-bar elements (10) attached over the glass and positioned on a first side of the solar module frame (30) to provide an enhanced set of mechanical loading characteristics with an increased predetermined loading threshold to withstand the meteorological impact from breaking the glass (26), each torque-bar element (10) including a body metal tubular member (12), a first gasket (14), and a first grounding washer (16), each torque-bar element (10) including a plurality of holes positioned to respective positions of the a column of holes (22a) in the corresponding solar module frame (30), the first gasket (14) being disposed between the glass (26) and the corresponding body metal tubular member (12) to provide a physical separation between the glass (26) and the corresponding body metal tubular member (12) for protecting the glass (26) from damage, the grounding washer (16) attached to corresponding body metal tubular member (12) for providing electrical grounding between the corresponding body metal tubular member (12) and the corresponding solar module frame (30).

The plurality of torque-bar elements comprises a first torque-bar element and a second torque-bar element, wherein the first torque-bar element is spaced apart from the second torque-bar element by a distance as to a desired amount of the enhanced set of mechanical loading characteristics with the increased predetermined loading threshold to withstand the meteorological impact from breaking the glass.

A solar module (20) comprises a solar module frame (30) surrounding a sheet of glass (26) overlaying a plurality of solar cells, the solar module frame (30) having a first set of holes (22a) in a direction and a second set of holes (22b) in the same direction, the solar module frame (30) having a set of mechanical loading characteristics with a predetermined loading threshold to withstand a meteorological impact from breaking the glass (26); a first torque-bar element (10) attached over the glass (26) and positioned on a first side of the solar module frame (30) to provide an enhanced set of mechanical loading characteristics with an increased predetermined loading threshold to withstand the meteorological impact from breaking the glass (26); and a second torque-bar element (10) attached over the glass (26) and positioned on a second side of the solar module frame (30) to provide the enhanced set of mechanical loading characteristics with an increased predetermined loading threshold to withstand the meteorological impact from breaking the glass (26).

The first torque-bar element (10) is spaced apart from the second torque-bar element (10) by a distance as to a desired amount of the enhanced set of mechanical loading characteristics with the increased predetermined loading threshold to withstand the meteorological impact from breaking the glass.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the embodiment(s). In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the embodiment(s).

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The terms “a” or “an,” as used herein, are defined as one or more than one. The term “plurality,” as used herein, is defined as two or more than two. The term “another,” as used herein, is defined as at least a second or more.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and its practical applications, to thereby enable others skilled in the art to best utilize the embodiments and various embodiments with various modifications as are suited to the particular use contemplated.

What is claimed and desired to be secured by Letters Patent of the United States is:

1. A solar module (20), comprising:
a solar module frame (30) surrounding a sheet of glass (26) overlaying a plurality of solar cells, the solar module frame (30) having a first column of holes (or a first row of holes (22a) and a second column of holes (or a second row of holes) (22b), the solar module frame (30) having a set of mechanical loading characteristics with a predetermined loading threshold to withstand a meteorological impact from breaking the glass (26);
a first torque-bar apparatus (10) attached over the glass and positioned on a first side of the solar module frame (30) to provide an enhanced set of mechanical loading characteristics with an increased predetermined loading threshold to withstand the meteorological impact from breaking the glass (26), the first torque-bar apparatus (10) including a first body metal tubular member (12a), a first gasket (14), and a first grounding washer (16), the first torque-bar apparatus (10) including a first plurality of holes positioned to match respective positions of the first column of holes (22a) in the solar module frame (30), the first gasket (14) being disposed between the glass (26) and the first body metal tubular member (12a) to provide a physical separation between the glass (26) and the first body metal tubular member (12a), thereby protecting the glass (26) from damage, the first grounding washer (16) being attached to the first body metal tubular member 12a for providing electrical grounding between the first body metal tubular member (12) and the solar module frame (30); and
a second torque-bar apparatus (10) attached over the glass (26) and positioned on a second side of the solar module frame (30) to provide the enhanced set of mechanical loading characteristics with an increased predetermined loading threshold to withstand the meteorological impact from breaking the glass (26), the second torque-bar apparatus (10) including a second body metal tubular member (12b), a second gasket (14), and a second grounding washer (16), the second torque-bar apparatus (10) including a second plurality of holes positioned to respective positions of the second column of holes (22b) in the solar module frame (30), the second gasket (14) being disposed between the glass (26) and the second body metal tubular member (12b) to provide a physical separation between the glass (26) and the body metal tubular member (12b), thereby protecting the glass (26) from damage, the second grounding washer (16) being attached to the second body metal tubular member (12b) for providing electrical grounding between the second body metal tubular member (12) and the solar module frame (30).

2. The solar module of claim 1, wherein the first body metal tubular member (12a) in the first torque-bar apparatus (10) is spaced apart from the second body metal tubular member (12b) by a distance as determined by the amount of the enhanced set of mechanical loading characteristics with the increased predetermined loading threshold to withstand the meteorological impact from breaking the glass (26).

3. The solar module of claim 1, wherein the first body metal tubular member (12a) and the second body metal tubular member (12b) are spaced apart by approximately 400 millimeter.

4. The solar module of claim 1, wherein the first body metal tubular member (12a) and the second body metal tubular member (12b) are spaced apart by approximately 1,200 millimeter.

5. The solar module of claim 1, wherein the first body metal tubular member (12a) and the second body metal tubular member (12b) are paced apart by approximately 1,400 millimeter.

6. The solar module of claim 1, wherein the enhanced set of mechanical loading characteristics strengthen the set of mechanical loading characteristics by at least 30% maximum loading capacity.

7. The solar module of claim 1, wherein the first torque-bar apparatus comprises an anodized aluminum material or a steel material.

8. The solar module of claim 1, wherein the second torque-bar apparatus comprises an anodized aluminum material or a steel material.

9. The solar module of claim 1, wherein the first torque-bar apparatus is bolted onto the solar module frame (30) with a first set of one or more screws, and wherein the second torque-bar apparatus is bolted onto the solar module frame (30) with a second set of one or more screws.

10. The solar module of claim 1, wherein the first torque-bar apparatus (10) is attached to the solar module frame (30) with a first set of rivets; and the second torque-bar apparatus (10) is attached to the solar module frame (30) a second set of rivets.

11. The solar module of claim 1, wherein each gasket (14) comprises a silicone gasket, a rubber gasket, or a non-rubber material.

12. The solar module of claim 1, wherein each gasket (14) comprises a spongy material or a spongy silicone.

13. The solar module of claim 1, wherein each gasket (14) is sufficiently thick to touch the glass when the corresponding body metal tubular member is mounted to the solar module frame (30).

14. The solar module of claim 1, wherein each gasket (14) has a thickness dependent on an original size of the solar module frame (30).

15. The solar module of claim 1, wherein each grounding washer (16) comprise stainless steel.

16. The solar module of claim 1, wherein the grounding washer (16) comprises a geometric shape, including circular, square, or rectangular.

17. A solar modules system, comprising:
a plurality of solar modules (20), each solar module (20) including a solar module frame (30) surrounding a sheet of glass (26) overlaying a plurality of solar cells, the solar module frame (30) having a first column of holes (or a first row of holes) (22a) and a second column of holes (or a second row of holes) (22b), the solar module frame (30) having a set of mechanical loading characteristics with a predetermined loading threshold to withstand a meteorological impact from breaking the glass (26); and
a plurality of torque-bar elements (10) attached over the glass and positioned on a first side of the solar module frame (30) to provide an enhanced set of mechanical loading characteristics with an increased predetermined loading threshold to withstand the meteorological impact from breaking the glass (26), each torque-bar element (10) including a body metal tubular member (12), a first gasket (14), and a first grounding washer (16), each torque-bar element (10) including a plurality of holes positioned to respective positions of the a column of holes (22a) in the corresponding solar module frame (30), the first gasket (14) being disposed between the glass (26) and the corresponding body metal tubular member (12) to provide a physical separation between the glass (26) and the corresponding body metal tubular member (12) for protecting the glass (26) from damage, the grounding washer (16) attached to corresponding body metal tubular member (12) for providing electrical grounding between the corresponding body metal tubular member (12) and the corresponding solar module frame (30).

18. The solar module of claim 17, wherein the plurality of torque-bar elements comprises a first torque-bar element and a second torque-bar element, wherein the first torque-bar element is spaced apart from the second torque-bar element by a distance as to a desired amount of the enhanced set of mechanical loading characteristics with the increased predetermined loading threshold to withstand the meteorological impact from breaking the glass.

19. A solar module (20), comprising:
a solar module frame (30) surrounding a sheet of glass (26) overlaying a plurality of solar cells, the solar module frame (30) having a first set of holes (22a) in a direction and a second set of holes (22b) in the same direction, the solar module frame (30) having a set of mechanical loading characteristics with a predetermined loading threshold to withstand a meteorological impact from breaking the glass (26);
a first torque-bar element (10) attached over the glass (26) and positioned on a first side of the solar module frame (30) to provide an enhanced set of mechanical loading characteristics with an increased predetermined loading threshold to withstand the meteorological impact from breaking the glass (26); and
a second torque-bar element (10) attached over the glass (26) and positioned on a second side of the solar module frame (30) to provide the enhanced set of mechanical loading characteristics with an increased predetermined loading threshold to withstand the meteorological impact from breaking the glass (26).

20. The solar module of claim 19, wherein the first torque-bar element (10) is spaced apart from the second torque-bar element (10) by a distance as to a desired amount of the enhanced set of mechanical loading characteristics with the increased predetermined loading threshold to withstand the meteorological impact from breaking the glass.
